(19) United States
(12) Patent Application Publication
(10) Pub. No.: US 2020/0141519 A1
(43) Pub. Date: May 7, 2020

(54) PIPE BEND STRUCTURE FOR REDUCING LOAD ON NOZZLE OF ROTATING DEVICE

(71) Applicant: L'Air Liquide, Société Anonyme pour I'Etude et I'Exploitation des Procédés Georges Claude, Paris (FR)

(72) Inventors: Hongzia SU, Zhejiang (CN); Zhiqiang LI, Zhejiang (LI); Wenhua WANG, Zhejiang (CN); Zhaoyang WANG, Zhejiang (CN)

(21) Appl. No.: 16/615,501

(22) PCT Filed: May 27, 2017
(86) PCT No.: PCT/CN2017/086259

§ 371 Date: Nov. 21, 2019

(51) Int. Cl. F16L 9/04; F16L 43/00

(52) U.S. Cl. CPC F16L 9/04; F16L 43/001

(57) ABSTRACT

Provided is a pipe bend structure for reducing the load on the nozzle of a rotating device, including a pipe bend, a reinforcing rib and a reinforcing plate. The reinforcing plate is arranged on an outer surface of the pipe bend, and the reinforcing rib is arranged on an inner arc side of the outer surface of the pipe bend. In the structure, the arrangement of the reinforcing rib and the reinforcing plate on the pipe bend increases the strength of the pipe bend, so that the stress in the pipe bend resulting from a pipe connected thereto can be relieved, ensuring the stable and reliable operation of the rotating device.

### TECHNICAL FIELD

The present invention relates to a pipe bend structure for reducing the load on a nozzle of a rotating apparatus, wherein a reinforcing rib and a reinforcing plate are disposed on the pipe bend, so that the strengthened pipe bend can unload the stress from a pipeline connected thereto, thereby avoiding transferring the stress to the rotating apparatus, and ensuring stable and reliable operation of the rotating apparatus.

### BACKGROUND ART

When a rotating apparatus is running, a pipe bend of a pipeline connected to the rotating apparatus often tears due to not being strongly supported. In order to solve this problem, a pipe bend bracket for a pipeline has been invented, and the existing support method for the pipe bend of the pipeline is that a support pipe is disposed under the pipe bend of the pipeline for supporting, but this support method cannot overcome a horizontal thrust and vertical gravity of the pipe bend of the pipeline at the same time. In the existing gas separation system, fluid is generally transported through pipelines, but the fluid inside a pipe line is greatly changed at the pipe bend of the pipeline due to the flow speed, flow direction and other working conditions, resulting in a great impact on the pipe bend of the pipeline, and causing the pipe line to vibrate. At present, mainly in the construction process of an engineering project, flexible pipe bends and flexible pipelines are usually used, and a support is welded near a joint between the flexible pipeline and the rigid pipeline to reduce vibration and improve the stability of the pipe bend of the pipeline. However, this existing method easily causes damage to the pipe line body, and the deformation of flexible pipe bend also affects the rotating apparatus.

A cryogenic liquid pump is a rotating apparatus commonly used in air separation units (ASU) and liquefied natural gas (LNG) facilities. An inlet and an outlet of the cryogenic liquid pump are connected to a fluid pipeline via flange bolts, and the quality of installation of the flange directly affects the safe operation of the rotating apparatus. When the fluid pipeline is connected to the inlet and the outlet of the rotating apparatus, the weight of the pipeline such as the pipe bend, a square pipe of variable diameter and a circular pipe of variable diameter shall not be applied to the rotating apparatus, and an expansion joint on the fluid pipeline must eliminate the force produced by thermal expansion and cold contraction, which force is definitely not permitted to be applied to the rotating apparatus. Due to the high speed operation of the pump, small vibrations can make a big difference to the operation of the pump. Therefore, the load on inlet and outlet nozzles of the rotating apparatus should be small, that is, the influence of stress of an external pipeline on the apparatus should be small, which is generally improved by the following methods: 1) increasing the wall thickness of the machine, and strengthening the load of the apparatus, 2) increasing the flexibility of the pipeline, and using a flexible pipe bend, and 3) adding an expansion joint, etc. near the nozzle; but each method has its own advantages and disadvantages. Therefore, the rotating apparatus particularly needs a suitable support device to reduce the load on the inlet and outlet nozzles of the rotating apparatus, preventing excessive stress on inlet and outlet pipelines from acting on the machine through the nozzles, and thus causing damage.

The prior art discloses a plurality of pipe bend support solutions, Chinese Patent No. CN 205154830 U discloses a hold hoop for fixing a pipe bend, the hold hoop comprising three pairs of clamping pieces connected by several bolts, wherein the pipe bend needs to be fixed to a straight pipe, and according to the included angle of the pipe bend, the clamping piece B rotates about a threaded hole C to adjust the angle. Chinese patent No. CN 205824371 U provides a stainless steel pipeline pipe bend bracket and support system, the pipe bend bracket comprising a vertical support pipe, a profile steel bracket horizontally connected to the top of the support pipe, a force-bearing arc piece connected to the end of the profile steel bracket, and a fixed ring horizontally connected to a top end of the force-bearing arc piece, wherein the center of the force-bearing arc piece and the profile steel bracket are located on both sides of the force-bearing arc piece, but which can only overcome a one-way horizontal thrust and vertical gravity applied to the pipe bend of the pipeline. Chinese Patent No. 205859360 U discloses a support device for a pipe bend of a pipeline, the support device comprising: a base, a support pipe, a pipe holder and a pipe clamp, wherein the support pipe is perpendicularly disposed on the base; the pipe holder has an arc shape and is disposed at a top end of the support pipe for holding the pipe bend of the pipeline; the pipe clamp is disposed on the pipe holder to form an annular passage enclosing the pipe bend of the pipeline; and axial and radial fluid impact forces applied to the pipe bend of the pipeline and the gravity of the pipe bend body of the pipeline are transferred to the support device for the pipe bend of the pipeline in this embodiment, thereby realizing the stability of the pipe bend of the pipeline during internal fluid impacts and reducing vibrations. Chinese patent No. CN 201258864 Y discloses a pump body structure of a vertical low-level flash cooling cycle axial flow pump, reinforcing ribs being uniformly welded between an outer side of an intermediate flow passage of a pump body and an inlet flange and an outlet flange, and pipe bends of different inclinations being disposed to change the angles of an inlet and an outlet of the entire pump body. Chinese patent No. CN 203926100 U provides a combined reinforcing rib structure disposed on parts and components of a large pump, the structure comprising an outlet reinforcing rib disposed on an outlet flow passage, several excircle reinforcing straight ribs and excircle reinforcing round ribs disposed between two flanges of the excircle of the components, and several incircle reinforcing straight ribs disposed between two flanges of the incircle of the parts and components, thereby improving the strength and rigidity of the parts and components, and reducing the vibration of a water pump. However, none of the above inventions provides a pipe bend structure which is simple in structure and which is suitable for reducing the load on a nozzle of a rotating apparatus.

### SUMMARY OF THE INVENTION

The present invention provides a pipe bend structure which is simple in structure and can reduce load on a nozzle of a rotating apparatus, reducing the load on the nozzle of the rotating apparatus due to the stress of a pipe bend, and ensuring stable and reliable operation of the rotating apparatus.

The present invention provides the following technical solution: a pipe bend structure for reducing the load on a nozzle of a rotating apparatus, the pipe bend structure comprising a pipe bend, a reinforcing rib and a reinforcing plate, characterized in that both ends of the pipe bend are respectively connected to the nozzle of the rotating apparatus and an external pipeline via flanges, the reinforcing plate is disposed on an outer surface of the pipe bend, and the reinforcing rib is disposed on an inner arc side of the outer surface of the pipe bend.

Preferably, two reinforcing plates are provided, and they have arc surfaces, are respectively fitted to both sides of the outer surface of the pipe bend, and are left-right symmetric with respect to an axial longitudinal section of the pipe bend.

Preferably, the thickness of the reinforcing plate is not less than the wall thickness of the pipe bend.

Preferably, the reinforcing rib has an arc shape and is fitted to the inner arc side of the pipe bend.

Preferably, the thickness of the reinforcing rib is not less than the wall thickness of the pipe bend.

Preferably, the material of each of the reinforcing plate and the reinforcing rib is selected from stainless steel or carbon steel.

Preferably, the reinforcing plate and the reinforcing rib are fixed to the pipe bend by means of welding.

Preferably, the pipe bend is a circular section pipe bend of 90 degrees.

Preferably, the pipe bend structure further comprises a support device, which comprises: a support pipe and a pipe holder, wherein the support pipe is perpendicularly disposed, and is freely movable in a perpendicular direction along a sleeve outside same; and the pipe holder has an arc surface and is disposed at a top end of the support pipe for holding the pipe bend, and an inner arc side of the arc surface pipe holder and an outer arc side of the pipe bend are fitted to each other.

Preferably, the pipe holder and the pipe bend are connected by means of welding.

Preferably, the rotating apparatus includes, but is not limited to, a turbine, a steam turbine, a turbomachine, a centrifugal compressor, and a cryogenic liquid pump.

The beneficial effects of the present invention are: a pipe bend structure for reducing the load on a nozzle of a rotating apparatus, which has a simple and novel structure and low costs, covers a small area, effectively improves the strength of a pipe bend and provides support, reduces the load on the nozzle of the rotating apparatus due to the stress of the pipe bend caused by the stress of a pipeline connected thereto, and ensures stable and reliable operation of the rotating apparatus.

(I) The flexible pipe bend is replaced by a rigid pipe bend, and the rigid pipe bend is strengthened by the reinforcing plate and the reinforcing rib to make it possible to unload the stress from the pipeline connected thereto and reduce the load on the nozzle of the rotating apparatus.

(II) Reinforcing plates are provided on both sides of the outer surface of the pipe bend, and the reinforcing rib is provided on the inner arc side of the outer surface of the pipe bend, so that the pipe bend is uniformly strengthened.

(III) A support device including a pipe holder is disposed at the lower part of the pipe bend, which can effectively unload the displacement of the pipe bend in a horizontal direction without increasing the stress in a vertical direction.

(IV) Since the rotating apparatus has a vertical displacement along the direction of the nozzle, the present invention does not limit the displacement of this direction, and effectively reduces the load on the nozzle of the rotating apparatus.

### BRIEF DESCRIPTION OF THE DRAWINGS

FIG. 1 is a schematic view of a pipe bend bracket connecting a cryogenic liquid pump in an existing air separation apparatus.

FIG. 2 is a schematic structural view of an embodiment of the present invention.

FIG. 3a is a side view of a pipe bend structure in an X direction in an embodiment of the present invention.

FIG. 3b is a side view of the pipe bend structure in a Z direction in an embodiment of the present invention.

1—Cryogenic liquid pump, 2—Outlet nozzle of pump, 3—Flexible pipe bend, 3—Pipe bend, 4—Flange, 5—Flexible pipe, 6—Rigid pipe, 7—Support frame, 8—Support pipe, 9—Pipe holder, 10—Reinforcing rib, 11—Reinforcing plate, 12—Sleeve.

### DETAILED DESCRIPTION

The present invention will be further described below in conjunction with the drawings and embodiments.

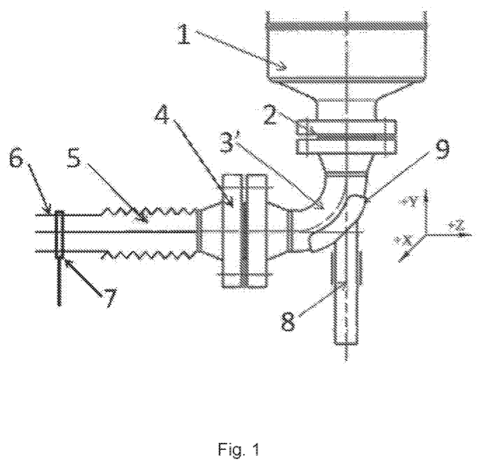

As shown in FIG. 1, in an existing air separation apparatus, a pipe bend connecting an outlet nozzle 2 of a cryogenic liquid pump 1 is a flexible pipe bend 3′, the other end thereof is connected to a flexible pipe 5 through a flange 4, the other end of the flexible pipe 5 is connected to a rigid pipe 6, and a support frame 7 is provided on the rigid pipe 6. The operating temperature of the cryogenic liquid pump 1 is about −190′ C, and the pump has a displacement in an axial direction (dy) of the nozzle, and has no displacement in other directions (dy≠0, dx=0, dz=0). A support pipe 8 is perpendicularly disposed, and a pipe holder 9 is of an arc surface and is disposed at a top end of the support pipe to ensure that the outlet nozzle 2 of the pump can only move along the axial direction (dy) of the nozzle. However, the stress from the pipe 6 can still be transferred to the outlet nozzle 2 of the pump through the pipe bend. It can be seen that the outlet nozzle 2 of the pump is connected to external piping through the pipe bend 3′, and a flexible elbow can unload some of the stress from the external piping. However, leakage of the cryogenic liquid pump is also easily caused due to the deformation of the flexible elbow itself and due to material-related reasons.

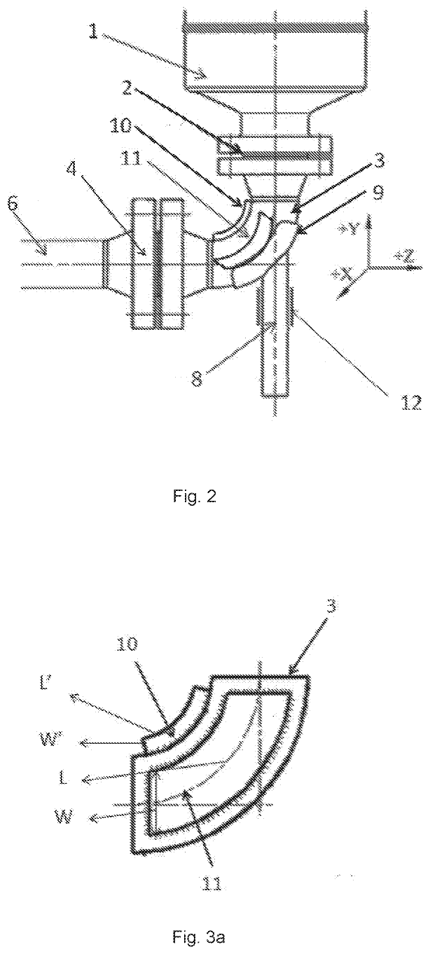

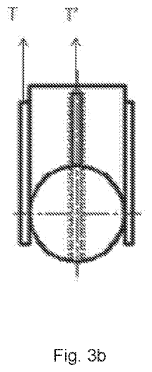

One embodiment of the present invention provides a pipe bend structure for reducing load on a nozzle of a rotating apparatus, in which embodiment the cryogenic liquid pump 1 has a displacement in the axial direction (dy) of the nozzle. As shown in FIG. 2, the device comprises a rigid pipe bend 3 having a size of DN80 (diameter)*7.62 (wall thickness) mm, and both ends of the pipe bend 3 are respectively connected to the nozzle 2 of the pump and the external rigid pipe 6 via flanges. As shown in FIG. 3a and FIG. 3b, two reinforcing plates 11 are provided, and they have arc surfaces, a thickness (T) of 10 mm, a central arc length (L) of 150 mm in a lengthwise direction, and an arc length (W) of 50 mm in a widthwise direction, are disposed on both sides of an outer surface of the pipe bend by means of welding (see FIG. 3a and FIG. 3b for details), and are closely fitted to the pipe bend symmetrically with respect to an axial longitudinal section of the pipe bend. A reinforcing rib 10 has an arc shape, has a thickness (T′) of 10 mm, an arc length (L′) of 50 mm along the axial direction of the pipe bend, and an arc length (W′) of 20 mm in the widthwise direction; the bending radius of the center line of the reinforcing rib in the axial direction of the pipe bend on the side where the reinforcing rib is connected to the pipe bend is consistent with the bending radius of an inner arc of the pipe bend; and the reinforcing rib is closely fitted to the inner arc of the outer surface of the pipe bend 3 by means of welding. A support device is provided at a lower part of the pipe bend structure, and comprises: a support pipe 8 and a pipe holder 9, wherein the support pipe 8 is perpendicularly disposed, and is freely movable in a vertical direction (dy) along a sleeve 12 outside same; the pipe holder 9 has an arc surface and is disposed at the top end of the support pipe, and an inner arc side of the arc surface pipe holder 9 and an outer arc side of the pipe bend 3 are closely fitted, both of which are connected by means of welding to support the pipe bend 3. According to the stiffness of an elbow, that is, the ability of the elbow to resist deformation when subjected to force, CAESARII pipeline stress analysis software (CAESARII 2014 from American company Intergraph) is used to calculate the load on the nozzle of the pump connecting the elbow (an unreinforced elbow and a reinforced elbow). Under installation working conditions, that is, under normal temperature working conditions, the pump does not operate, the stress in the dy direction is mainly the gravity of the device; and under operating working conditions, the pump operates at a low temperature, and the stress in the dy direction is mainly the stress caused by low temperature shrinkage of metal. For the pipe bend which is not reinforced by the reinforcing rib and the reinforcing plate, even if there is a support device to unload the stress in a horizontal direction, compared with the present invention, the stress in the dx direction is still large under the operating working conditions. In the present invention, the lateral line force Fx applied to the nozzle of the pump is significantly reduced, and the load of the nozzle in the horizontal direction is significantly lowered. The specific line forces {Fx, Fy, Fz} and torques {Mx, My, Mz} change as follows:

TABLE 1
Analysis data of respective axial forces and torques before and
after the addition of the reinforcing plates and the reinforcing
rib in the embodiment of the present invention (FIG. 2)

| | Working | Fx | Fy | Fz | Mx | My | Mz |
|---|---|---|---|---|---|---|---|
| | condition | (N) | (N) | (N) | (N · m) | (N · m) | (N · m) |
| Comparative | Installation | 35 | −769 | 0 | 0 | 0 | −24 |
| example | working | | | | | | |
| (without the | conditions | | | | | | |
| reinforcing | (normal | | | | | | |
| plates and the | temperature | | | | | | |
| reinforcing rib) | working | | | | | | |
| | conditions) | | | | | | |
| | Operating | −2031 | 1672 | −8 | 0 | 1 | −478 |
| | working | | | | | | |
| | conditions | | | | | | |
| | (cold working | | | | | | |
| | conditions) | | | | | | |
| Embodiment | Installation | 71 | −810 | 0 | 0 | 0 | −35 |
| of the present | working | | | | | | |
| invention | conditions | | | | | | |
| (with the | (normal | | | | | | |
| reinforcing | temperature | | | | | | |
| plates and the | working | | | | | | |
| reinforcing | conditions) | | | | | | |
| rib as in FIG. 2) | Operating | 730 | 1682 | −8 | −1 | 1 | −395 |
| | working | | | | | | |
| | conditions | | | | | | |
| | (cold working | | | | | | |
| | conditions) | | | | | | |

The above embodiments are merely preferred embodiments of the present invention, but are not intended to limit the present invention, and any simple modifications, alterations, and equivalent structural changes made to the above embodiments in accordance with the technical substance of the present invention still fall within the scope of protection of the technical solutions of the present invention. Meanwhile, the terms that are cited in this specification such as “upper”, “lower”, “left”, “right” and “a/an” are merely intended for convenience of description rather than to limit the implementable scope of the present invention, and the changes or adjustments of the relative relationship thereof should be seen as the implementable scope of the present invention without substantial changes in the technical content.

1.-11. (canceled)

12. A pipe bend structure for reducing the load on a nozzle of a rotating apparatus, the pipe bend structure comprising a pipe bend, a reinforcing rib and a reinforcing plate, wherein both ends of the pipe bend are respectively connected to the nozzle of the rotating apparatus and an external pipeline via flanges, the reinforcing plate is disposed on an outer surface of the pipe bend, and the reinforcing rib is disposed on an inner arc side of the outer surface of the pipe bend.

13. The pipe bend structure as claimed in claim 12, further comprising two reinforcing plates comprising arc surfaces, respectively fitted to both sides of the outer surface of the pipe bend and are left-right symmetric with respect to an axial longitudinal section of the pipe bend.

14. The pipe bend structure as claimed in claim 12, wherein the thickness of the reinforcing plate is not less than the wall thickness of the pipe bend.

15. The pipe bend structure as claimed in claim 12, wherein the reinforcing rib has an arc shape and is fitted to the inner arc side of the pipe bend.

16. The pipe bend structure as claimed in claim 15, wherein the thickness of the reinforcing rib is not less than the wall thickness of the pipe bend.

17. The pipe bend structure as claimed in claim 12, wherein the material of each of the reinforcing plate and the reinforcing rib is selected from stainless steel or carbon steel.

18. The pipe bend structure as claimed in claim 17, wherein the reinforcing plate and the reinforcing rib are fixed to the pipe bend by means of welding.

19. The pipe bend structure as claimed in claim 12, wherein the pipe bend is a circular section pipe bend of 90 degrees.

20. The pipe bend structure as claimed in claim 12, wherein the pipe bend structure further comprises a support device, which comprises: a support pipe and a pipe holder, wherein the support pipe is perpendicularly disposed, and is freely movable in a perpendicular direction along a sleeve outside same; the pipe holder has an arc surface and is disposed at a top end of the support pipe for holding the pipe bend, and an inner arc side of the arc surface pipe holder and an outer arc side of the pipe bend are fitted to each other.

21. The pipe bend structure as claimed in claim 20, wherein the pipe holder and the pipe bend are connected by means of welding.

22. The pipe bend structure as claimed in claim 12, wherein the rotating apparatus comprises a turbine, a steam turbine, a turbomachine, a centrifugal compressor, and/or a cryogenic liquid pump.
